(19) United States
(12) Patent Application Publication
(10) Pub. No.: US 2026/0262079 A1
(43) Pub. Date: Sep. 3, 2026

(54) METHOD AND APPARATUS FOR LBT IN SIDELINK COMMUNICATION OF UNLICENSED BAND

(71) Applicants: HYUNDAI MOTOR COMPANY, SEOUL (KR); KIA CORPORATION, SEOUL (KR)

(72) Inventor: Ui Hyun Hong, Hwaseong-si (KR)

(73) Assignees: HYUNDAI MOTOR COMPANY, SEOUL (KR); KIA CORPORATION, SEOUL (KR)

(21) Appl. No.: 18/846,962

(22) PCT Filed: Jun. 20, 2023
(86) PCT No.: PCT/KR2023/008523

§ 371 Date: Sep. 13, 2024

(30) Foreign Application Priority Data
Jun. 29, 2022 (KR) 10-2022-0079900
Aug. 8, 2022 (KR) 10-2022-0098740

(51) Int. Cl. H04W 74/0808; H04L 1/1812; H04W 72/25

(52) U.S. Cl. CPC H04W 74/0808; H04L 1/1812; H04W 72/25

(57) ABSTRACT

A method and an apparatus for LBT in sidelink communication of an unlicensed band are disclosed. The method of a first UE comprises the steps of: transmitting, to a second UE, configuration information about one or more LBT symbols by which an LBT operation can be performed; transmitting scheduling information about data to the second UE; transmitting the data to the second UE on the basis of the scheduling information; and receiving HARQ-ACK information for the data from the second UE.

### TECHNICAL FIELD

The present disclosure relates to a sidelink communication technique, and more particularly, to a technique for listen before talk (LBT) operations.

### BACKGROUND ART

A communication network (e.g., 5G communication network or 6G communication network) is being developed to provide enhanced communication services compared to the existing communication networks (e.g., long term evolution (LTE), LTE-Advanced (LTE-A), etc.). The 5G communication network (e.g., New Radio (NR) communication network) can support frequency bands both below 6 GHz and above 6 GHZ. In other words, the 5G communication network can support both a frequency region 1 (FR1) and/or FR2 bands. Compared to the LTE communication network, the 5G communication network can support various communication services and scenarios. For example, usage scenarios of the 5G communication network may include enhanced Mobile BroadBand (eMBB), Ultra Reliable Low Latency Communication (URLLC), massive Machine Type Communication (mMTC), and the like.

The 6G communication network can support a variety of communication services and scenarios compared to the 5G communication network. The 6G communication network can meet the requirements of hyper-performance, hyper-bandwidth, hyper-space, hyper-precision, hyper-intelligence, and/or hyper-reliability. The 6G communication network can support diverse and wide frequency bands and can be applied to various usage scenarios such as terrestrial communication, non-terrestrial communication, sidelink communication, and the like.

Meanwhile, in order to improve sidelink communication, operations such as carrier aggregation (CA), unlicensed band operations, FR2 band operations, and/or coexistence between LTE and NR may be considered. In particular, if sidelink communication is performed in an unlicensed band, methods to support the sidelink communication may be needed. For operations in the unlicensed band, optimization of sidelink physical channel structures may be needed. Additionally, improvement of a listen before talk (LBT) operation for sidelink communication in the unlicensed band may be needed.

### DISCLOSURE

### Technical Problem

The present disclosure is directed to providing a method and an apparatus for LBT operations in unlicensed band sidelink communication.

### Technical Solution

A method of a first user equipment (UE), according to a first exemplary embodiment of the present disclosure for achieving the above-described objective, may comprise: transmitting, to a second UE, configuration information of one or more listen before talk (LBT) symbols capable of performing an LBT operation; transmitting scheduling information of data to the second UE; transmitting the data to the second UE based on the scheduling information; and receiving hybrid automatic repeat request-acknowledgement (HARQ-ACK) information for the data from the second UE, wherein an LBT operation of the second UE for transmitting the HARQ-ACK information is performed in at least one LBT symbol among the one or more LBT symbols.

The configuration information and the scheduling information may be included in same sidelink control information (SCI) or different signaling messages.

The one or more LBT symbols may be configured within one physical sidelink feedback channel (PSFCH) slot, and the one PSFCH slot may include a PSFCH resource for transmitting the HARQ-ACK information.

The configuration information may include at least one of a symbol index for each of the one or more LBT symbols, an index of a first LBT symbol among the one or more LBT symbols, an index of a reference LBT symbol among the one or more LBT symbols, an index of a last LBT symbol among the one or more LBT symbols, a number of the one or more LBT symbols, a symbol offset between the first LBT symbol and the last LBT symbol, a configuration periodicity of the one or more LBT symbols, or a bitmap indicating the one or more LBT symbols.

The one or more LBT symbols may be configured considering a minimum number of symbols required for transmission of the data.

The one or more LBT symbols may be configured considering a configuration periodicity of a PSFCH resource included in a PSFCH slot.

A method of a second UE, according to a second exemplary embodiment of the present disclosure for achieving the above-described objective, may comprise: receiving configuration information of one or more listen before talk (LBT) symbols capable of performing an LBT operation; receiving scheduling information of data from a first UE; receiving the data from the first UE based on the scheduling information; and performing a first LBT operation in a first LBT symbol among the one or more LBT symbols indicated by the configuration information to transmit hybrid automatic repeat request-acknowledgement (HARQ-ACK) information for the data.

The method may further comprise: in response to a failure of the first LBT operation, performing a second LBT operation in a second LBT symbol among the one or more LBT symbols; and in response to a success of the second LBT operation, transmitting the HARQ-ACK information to the first UE.

The configuration information may be received through signaling from the first UE or a base station.

The configuration information and the scheduling information may be included in same sidelink control information (SCI) or different signaling messages received from the first UE.

The one or more LBT symbols may be configured within one physical sidelink feedback channel (PSFCH) slot, and the one PSFCH slot may include a PSFCH resource for transmitting the HARQ-ACK information.

The configuration information may include at least one of a symbol index for each of the one or more LBT symbols, an index of a first LBT symbol among the one or more LBT symbols, an index of a reference LBT symbol among the one or more LBT symbols, an index of a last LBT symbol among the one or more LBT symbols, a number of the one or more LBT symbols, a symbol offset between the first LBT symbol and the last LBT symbol, a configuration periodicity of the one or more LBT symbols, or a bitmap indicating the one or more LBT symbols.

The one or more LBT symbols may be configured considering a minimum number of symbols required for transmission of the data.

The one or more LBT symbols may be configured considering a configuration periodicity of a PSFCH resource included in a PSFCH slot.

A second UE, according to a third exemplary embodiment of the present disclosure for achieving the above-described objective, may comprise a processor, and the processor causes the second UE to perform: receiving configuration information of one or more listen before talk (LBT) symbols capable of performing an LBT operation; receiving scheduling information of data from a first UE; receiving the data from the first UE based on the scheduling information; and performing a first LBT operation in a first LBT symbol among the one or more LBT symbols indicated by the configuration information to transmit hybrid automatic repeat request-acknowledgement (HARQ-ACK) information for the data.

The processor may further cause the second UE to perform: in response to a failure of the first LBT operation, performing a second LBT operation in a second LBT symbol among the one or more LBT symbols; and in response to a success of the second LBT operation, transmitting the HARQ-ACK information to the first UE.

The configuration information and the scheduling information may be included in same sidelink control information (SCI) or different signaling messages received from the first UE.

The one or more LBT symbols may be configured within one physical sidelink feedback channel (PSFCH) slot, and the one PSFCH slot may include a PSFCH resource for transmitting the HARQ-ACK information.

The configuration information may include at least one of a symbol index for each of the one or more LBT symbols, an index of a first LBT symbol among the one or more LBT symbols, an index of a reference LBT symbol among the one or more LBT symbols, an index of a last LBT symbol among the one or more LBT symbols, a number of the one or more LBT symbols, a symbol offset between the first LBT symbol and the last LBT symbol, a configuration periodicity of the one or more LBT symbols, or a bitmap indicating the one or more LBT symbols.

The one or more LBT symbols may be configured considering a minimum number of symbols required for transmission of the data or a configuration periodicity of a PSFCH resource included in a PSFCH slot.

### Advantageous Effects

According to the present disclosure, a terminal can receive configuration information for LBT symbols, perform an LBT operation in the LBT symbol(s) indicated by the configuration information, and transmit data if the LBT operation succeeds. A plurality of LBT symbols may be configured within a single physical sidelink feedback channel (PSFCH) slot. In this case, the terminal can perform a first LBT operation in the first LBT symbol among the plurality of LBT symbols, and if the first LBT operation fails, the terminal can perform a second LBT operation in the second LBT symbol among the plurality of LBT symbols. According to this method, a transmission delay of feedback information caused by the LBT operation failure can be prevented. Consequently, the performance of the communication system can be improved.

### DESCRIPTION OF DRAWINGS

FIG. 1 is a conceptual diagram illustrating scenarios of Vehicle-to-Everything (V2X) communications.

FIG. 2 is a conceptual diagram illustrating a first exemplary embodiment of a communication system.

FIG. 3 is a conceptual diagram illustrating a first exemplary embodiment of a communication node constituting a communication system.

FIG. 4 is a block diagram illustrating a first exemplary embodiment of communication nodes performing communication.

FIG. 5A is a block diagram illustrating a first exemplary embodiment of a transmission path.

FIG. 5B is a block diagram illustrating a first exemplary embodiment of a reception path.

FIG. 6 is a block diagram illustrating a first exemplary embodiment of a user plane protocol stack of a UE performing sidelink communication.

FIG. 7 is a block diagram illustrating a first exemplary embodiment of a control plane protocol stack of a UE performing sidelink communication.

FIG. 8 is a block diagram illustrating a second exemplary embodiment of a control plane protocol stack of a UE performing sidelink communication.

FIG. 9 is a timing diagram illustrating a first exemplary embodiment of a communication method in an unlicensed band.

FIG. 10 is a conceptual diagram illustrating a first exemplary embodiment of an LBT operation in SL-U communication.

FIG. 11 is a conceptual diagram illustrating a second exemplary embodiment of an LBT operation in SL-U communication.

FIG. 12 is a conceptual diagram illustrating a third exemplary embodiment of an LBT operation in SL-U communication.

FIG. 13 is a conceptual diagram illustrating a fourth exemplary embodiment of an LBT operation in SL-U communication.

FIG. 14 is a conceptual diagram illustrating a fifth exemplary embodiment of an LBT operation in SL-U communication.

FIG. 15 is a conceptual diagram illustrating a sixth exemplary embodiment of an LBT operation in SL-U communication.

FIG. 16 is a conceptual diagram illustrating a seventh exemplary embodiment of an LBT operation in SL-U communication.

FIG. 17 is a conceptual diagram illustrating an eighth exemplary embodiment of an LBT operation in SL-U communication.

FIG. 18 is a conceptual diagram illustrating a ninth exemplary embodiment of an LBT operation in SL-U communication.

FIG. 19 is a sequence chart illustrating a first exemplary embodiment of an SL-U communication method.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re) transmission’ may refer to ‘transmission’, ‘retransmission’, or ‘transmission and retransmission’, ‘(re) configuration’ may refer to ‘configuration’, ‘reconfiguration’, or ‘configuration and reconfiguration’, ‘(re) connection’ may refer to ‘connection’, ‘reconnection’, or ‘connection and reconnection’, and ‘(re) access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted. The operations according to the exemplary embodiments described explicitly in the present disclosure, as well as combinations of the exemplary embodiments, extensions of the exemplary embodiments, and/or variations of the exemplary embodiments, may be performed. Some operations may be omitted, and a sequence of operations may be altered.

Even when a method (e.g., transmission or reception of a signal) to be performed at a first communication node among communication nodes is described in exemplary embodiments, a corresponding second communication node may perform a method (e.g., reception or transmission of the signal) corresponding to the method performed at the first communication node. That is, when an operation of a user equipment (UE) is described, a base station corresponding thereto may perform an operation corresponding to the operation of the UE. Conversely, when an operation of a base station is described, a corresponding UE may perform an operation corresponding to the operation of the base station.

The base station may be referred to by various terms such as NodeB, evolved NodeB, next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and the like. The user equipment (UE) may be referred to by various terms such as terminal, device, apparatus, node, communication node, end node, access terminal, mobile terminal, station, subscriber station, mobile station, portable subscriber station, on-board unit (OBU), and the like.

In the present disclosure, signaling may be one or a combination of two or more of higher layer signaling, MAC signaling, and physical (PHY) signaling. A message used for higher layer signaling may be referred to as a ‘higher layer message’ or ‘higher layer signaling message’. A message used for MAC signaling may be referred to as a ‘MAC message’ or ‘MAC signaling message’. A message used for PHY signaling may be referred to as a ‘PHY message’ or ‘PHY signaling message’. The higher layer signaling may refer to an operation of transmitting and receiving system information (e.g., master information block (MIB), system information block (SIB)) and/or an RRC message. The MAC signaling may refer to an operation of transmitting and receiving a MAC control element (CE). The PHY signaling may refer to an operation of transmitting and receiving control information (e.g., downlink control information (DCI), uplink control information (UCI), or sidelink control information (SCI)).

In the present disclosure, ‘configuration of an operation (e.g., transmission operation)’ may refer to signaling of configuration information (e.g., information elements, parameters) required for the operation and/or information indicating to perform the operation. ‘configuration of information elements (e.g., parameters)’ may refer to signaling of the information elements. In the present disclosure, ‘signal and/or channel’ may refer to signal, channel, or both signal and channel, and ‘signal’ may be used to mean ‘signal and/or channel’.

A communication network to which exemplary embodiments are applied is not limited to that described below, and the exemplary embodiments may be applied to various communication networks (e.g., 4G communication networks, 5G communication networks, and/or 6G communication networks). Here, ‘communication network’ may be used interchangeably with a term ‘communication system’.

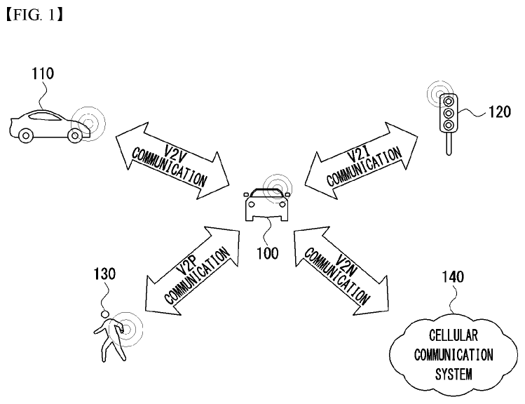

FIG. 1 is a conceptual diagram illustrating scenarios of Vehicle-to-Everything (V2X) communications.

As shown in FIG. 1, V2X communications may include Vehicle-to-Vehicle (V2V) communications, Vehicle-to-Infrastructure (V2I) communications, Vehicle-to-Pedestrian (V2P) communications, Vehicle-to-Network (V2N) communications, and the like. The V2X communications may be supported by a communication system (e.g., communication network) 140, and the V2X communications supported by the communication system 140 may be referred to as ‘Cellular-V2X (C-V2X) communications’. Here, the communication system 140 may include the 4G communication system (e.g., LTE communication system or LTE-A communication system), 5G communication system (e.g., NR communication system), and the like.

The V2V communications may include communications between a first vehicle 100 (e.g., a communication node located in the vehicle 100) and a second vehicle 110 (e.g., a communication node located in the vehicle 110). Various driving information such as velocity, heading, time, position, and the like may be exchanged between the vehicles 100 and 110 through the V2V communications. For example, autonomous driving (e.g., platooning) may be supported based on the driving information exchanged through the V2V communications. The V2V communications supported by the communication system 140 may be performed based on sidelink communication technologies (e.g., Proximity Based Services (ProSe) and Device-to-Device (D2D) communication technologies, and the like). In this case, the communications between the vehicles 100 and 110 may be performed using at least one sidelink channel.

The V2I communications may include communications between the first vehicle 100 and an infrastructure (e.g., road side unit (RSU)) 120 located on a roadside. The infrastructure 120 may include a traffic light or a street light which is located on the roadside. For example, when the V2I communications are performed, the communications may be performed between the communication node located in the first vehicle 100 and a communication node located in a traffic light. Traffic information, driving information, and the like may be exchanged between the first vehicle 100 and the infrastructure 120 through the V2I communications. The V2I communications supported by the communication system 140 may be performed based on sidelink communication technologies (e.g., ProSe and D2D communication technologies, and the like). In this case, the communications between the vehicle 100 and the infrastructure 120 may be performed using at least one sidelink channel.

The V2P communications may include communications between the first vehicle 100 (e.g., the communication node located in the vehicle 100) and a person 130 (e.g., a communication node carried by the person 130). The driving information of the first vehicle 100 and movement information of the person 130 such as velocity, heading, time, position, and the like may be exchanged between the vehicle 100 and the person 130 through the V2P communications. The communication node located in the vehicle 100 or the communication node carried by the person 130 may generate an alarm indicating a danger by judging a dangerous situation based on the obtained driving information and movement information. The V2P communications supported by the communication system 140 may be performed based on sidelink communication technologies (e.g., ProSe and D2D communication technologies, and the like). In this case, the communications between the communication node located in the vehicle 100 and the communication node carried by the person 130 may be performed using at least one sidelink channel.

The V2N communications may be communications between the first vehicle 100 (e.g., the communication node located in the vehicle 100) and the communication system (e.g., communication network) 140. The V2N communications may be performed based on the 4G communication technology (e.g., LTE or LTE-A specified as the 3GPP standards) or the 5G communication technology (e.g., NR specified as the 3GPP standards). Also, the V2N communications may be performed based on a Wireless Access in Vehicular Environments (WAVE) communication technology or a Wireless Local Area Network (WLAN) communication technology which is defined in Institute of Electrical and Electronics Engineers (IEEE) 802.11, a Wireless Personal Area Network (WPAN) communication technology defined in IEEE 802.15, or the like.

Meanwhile, the communication system 140 supporting the V2X communications may be configured as follows.

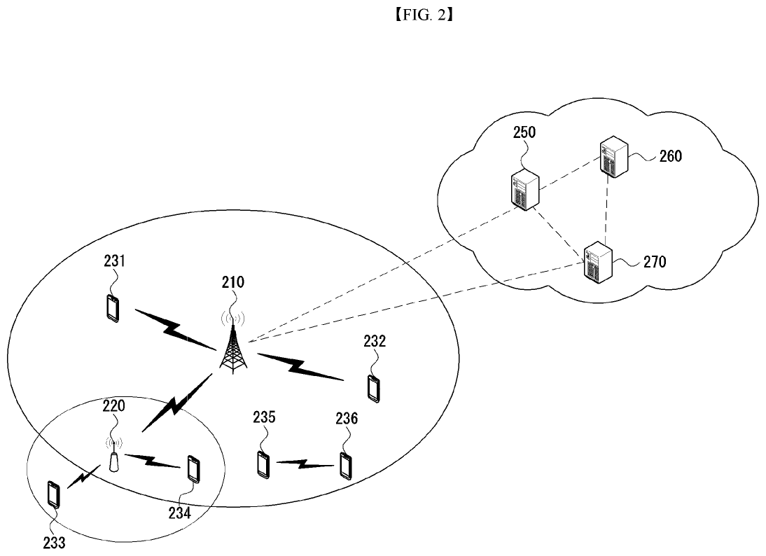

FIG. 2 is a conceptual diagram illustrating a first exemplary embodiment of a communication system.

As shown in FIG. 2, a communication system may include an access network, a core network, and the like. The access network may include a base station 210, a relay 220, user equipment (UEs) 231 through 236, and the like. The UEs 231 through 236 may include communication nodes located in the vehicles 100 and 110 of FIG. 1, the communication node located in the infrastructure 120 of FIG. 1, the communication node carried by the person 130 of FIG. 1, and the like. When the communication system supports the 4G communication technology, the core network may include a serving gateway (S-GW) 250, a packet data network (PDN) gateway (P-GW) 260, a mobility management entity (MME) 270, and the like.

When the communication system supports the 5G communication technology, the core network may include a user plane function (UPF) 250, a session management function (SMF) 260, an access and mobility management function (AMF) 270, and the like. Alternatively, when the communication system operates in a Non-Stand Alone (NSA) mode, the core network constituted by the S-GW 250, the P-GW 260, and the MME 270 may support the 5G communication technology as well as the 4G communication technology, and the core network constituted by the UPF 250, the SMF 260, and the AMF 270 may support the 4G communication technology as well as the 5G communication technology.

In addition, when the communication system supports a network slicing technique, the core network may be divided into a plurality of logical network slices. For example, a network slice supporting V2X communications (e.g., a V2V network slice, a V2I network slice, a V2P network slice, a V2N network slice, etc.) may be configured, and the V2X communications may be supported through the V2X network slices configured in the core network.

The communication nodes (e.g., base station, relay, UE, S-GW, P-GW, MME, UPF, SMF, AMF, etc.) constituting the communication system may perform communications by using at least one communication technology among a code division multiple access (CDMA) technology, a time division multiple access (TDMA) technology, a frequency division multiple access (FDMA) technology, an orthogonal frequency division multiplexing (OFDM) technology, a filtered OFDM technology, an orthogonal frequency division multiple access (OFDMA) technology, a single carrier FDMA (SC-FDMA) technology, a non-orthogonal multiple access (NOMA) technology, a generalized frequency division multiplexing (GFDM) technology, a filter bank multi-carrier (FBMC) technology, a universal filtered multi-carrier (UFMC) technology, and a space division multiple access (SDMA) technology.

The communication nodes (e.g., base station, relay, UE, S-GW, P-GW, MME, UPF, SMF, AMF, etc.) constituting the communication system may be configured as follows.

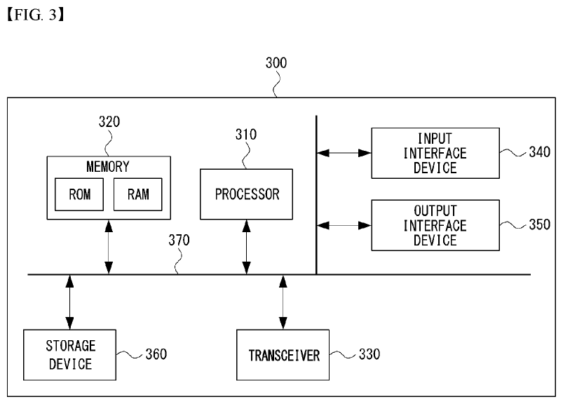

FIG. 3 is a conceptual diagram illustrating a first exemplary embodiment of a communication node constituting a communication system.

As shown in FIG. 3, a communication node 300 may comprise at least one processor 310, a memory 320, and a transceiver 330 connected to a network for performing communications. Also, the communication node 300 may further comprise an input interface device 340, an output interface device 350, a storage device 360, and the like. Each component included in the communication node 300 may communicate with each other as connected through a bus 370.

However, each of the components included in the communication node 300 may be connected to the processor 310 via a separate interface or a separate bus rather than the common bus 370. For example, the processor 310 may be connected to at least one of the memory 320, the transceiver 330, the input interface device 340, the output interface device 350, and the storage device 360 via a dedicated interface.

The processor 310 may execute at least one program command stored in at least one of the memory 320 and the storage device 360. The processor 310 may refer to a central processing unit (CPU), a graphics processing unit (GPU), or a dedicated processor on which methods in accordance with exemplary embodiments of the present disclosure are performed. Each of the memory 320 and the storage device 360 may include at least one of a volatile storage medium and a non-volatile storage medium. For example, the memory 320 may comprise at least one of read-only memory (ROM) and random access memory (RAM).

Referring again to FIG. 2, in the communication system, the base station 210 may form a macro cell or a small cell, and may be connected to the core network via an ideal backhaul or a non-ideal backhaul. The base station 210 may transmit signals received from the core network to the UEs 231 through 236 and the relay 220, and may transmit signals received from the UEs 231 through 236 and the relay 220 to the core network. The UEs 231, 232, 234, 235 and 236 may belong to a cell coverage of the base station 210. The UEs 231, 232, 234, 235 and 236 may be connected to the base station 210 by performing a connection establishment procedure with the base station 210. The UEs 231, 232, 234, 235 and 236 may communicate with the base station 210 after being connected to the base station 210.

The relay 220 may be connected to the base station 210 and may relay communications between the base station 210 and the UEs 233 and 234. That is, the relay 220 may transmit signals received from the base station 210 to the UEs 233 and 234, and may transmit signals received from the UEs 233 and 234 to the base station 210. The UE 234 may belong to both of the cell coverage of the base station 210 and the cell coverage of the relay 220, and the UE 233 may belong to the cell coverage of the relay 220. That is, the UE 233 may be located outside the cell coverage of the base station 210. The UEs 233 and 234 may be connected to the relay 220 by performing a connection establishment procedure with the relay 220. The UEs 233 and 234 may communicate with the relay 220 after being connected to the relay 220.

The base station 210 and the relay 220 may support multiple-input multiple-output (MIMO) technologies (e.g., single user (SU)-MIMO, multi-user (MU)-MIMO, massive MIMO, etc.), coordinated multipoint (COMP) communication technologies, carrier aggregation (CA) communication technologies, unlicensed band communication technologies (e.g., Licensed Assisted Access (LAA), enhanced LAA (eLAA), etc.), sidelink communication technologies (e.g., ProSe communication technology, D2D communication technology), or the like. The UEs 231, 232, 235 and 236 may perform operations corresponding to the base station 210 and operations supported by the base station 210. The UEs 233 and 234 may perform operations corresponding to the relays 220 and operations supported by the relays 220.

Here, the base station 210 may be referred to as a Node B (NB), evolved Node B (eNB), base transceiver station (BTS), radio remote head (RRH), transmission reception point (TRP), radio unit (RU), roadside unit (RSU), radio transceiver, access point, access node, or the like. The relay 220 may be referred to as a small base station, relay node, or the like. Each of the UEs 231 through 236 may be referred to as a terminal, access terminal, mobile terminal, station, subscriber station, mobile station, portable subscriber station, node, device, on-broad unit (OBU), or the like.

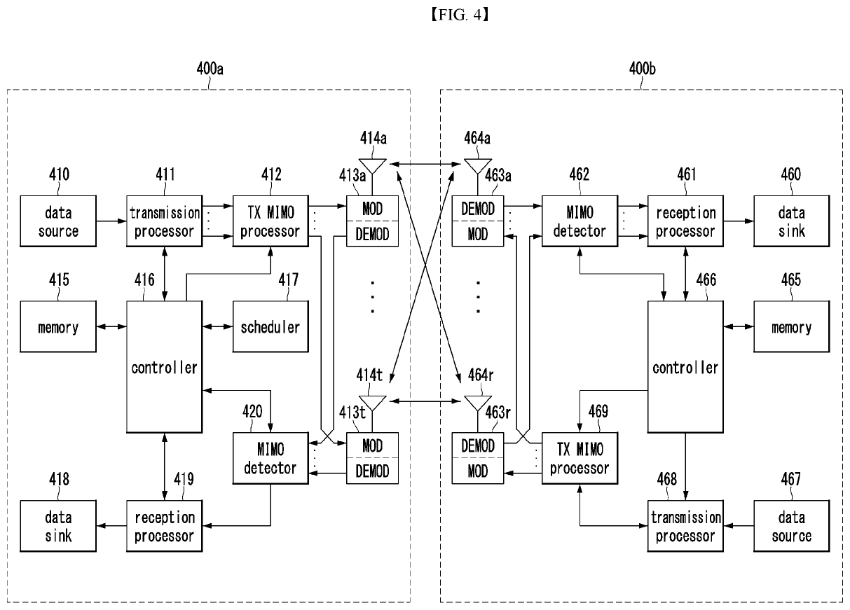

Meanwhile, communication nodes that perform communications in the communication network may be configured as follows. A communication node shown in FIG. 4 may be a specific exemplary embodiment of the communication node shown in FIG. 3.

FIG. 4 is a block diagram illustrating a first exemplary embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g., data unit) from a data source 410. The transmission processor 411 may receive control information from a controller 416. The control information may include at least one of system information, RRC configuration information (e.g., information configured by RRC signaling), MAC control information (e.g., MAC CE), or PHY control information (e.g., DCI, SCI).

The transmission processor 411 may generate data symbol(s) by performing processing operations (e.g., encoding operation, symbol mapping operation, etc.) on the data. The transmission processor 411 may generate control symbol(s) by performing processing operations (e.g., encoding operation, symbol mapping operation, etc.) on the control information. In addition, the transmission processor 411 may generate synchronization/reference symbol(s) for synchronization signals and/or reference signals.

A Tx MIMO processor 412 may perform spatial processing operations (e.g., precoding operations) on the data symbol(s), control symbol(s), and/or synchronization/reference symbol(s). An output (e.g., symbol stream) of the Tx MIMO processor 412 may be provided to modulators (MODs) included in transceivers 413a to 413t. The modulator may generate modulation symbols by performing processing operations on the symbol stream, and may generate signals by performing additional processing operations (e.g., analog conversion operations, amplification operation, filtering operation, up-conversion operation, etc.) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g., filtering operation, amplification operation, down-conversion operation, digital conversion operation, etc.) on the signals. The demodulator may perform additional processing operations on the samples to obtain symbols. A MIMO detector 462 may perform MIMO detection operations on the symbols. A reception processor 461 may perform processing operations (e.g., de-interleaving operation, decoding operation, etc.) on the symbols. An output of the reception processor 461 may be provided to a data sink 460 and a controller 466. For example, the data may be provided to the data sink 460 and the control information may be provided to the controller 466.

On the other hand, the second communication node 400b may transmit signals to the first communication node 400a. A transmission processor 469 included in the second communication node 400b may receive data (e.g., data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g., precoding operations) on the data symbol(s), control symbol(s), and/or reference symbol(s). An output (e.g., symbol stream) of the Tx MIMO processor 469 may be provided to modulators (MODs) included in the transceivers 463a to 463t. The modulator may generate modulation symbols by performing processing operations on the symbol stream, and may generate signals by performing additional processing operations (e.g., analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g., filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g., de-interleaving operation, decoding operation, etc.) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may be the processor 310 shown in FIG. 3, and may be used to perform methods described in the present disclosure.

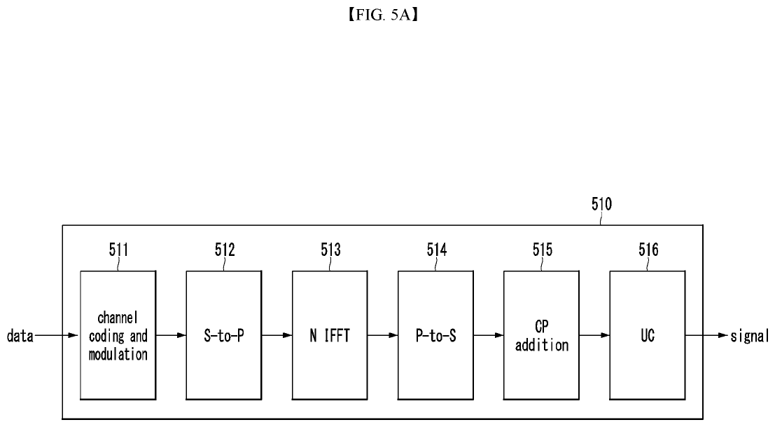

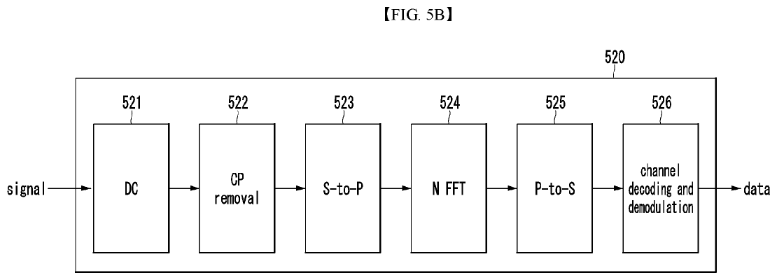

FIG. 5A is a block diagram illustrating a first exemplary embodiment of a transmission path, and FIG. 5B is a block diagram illustrating a first exemplary embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse fast Fourier transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point FFT block 524, a P-to-S block 525, and a channel decoding and demodulation block 526. Here, N may be a natural number.

In the transmission path 510, information bits may be input to the channel coding and modulation block 511. The channel coding and modulation block 511 may perform a coding operation (e.g., low-density parity check (LDPC) coding operation, polar coding operation, etc.) and a modulation operation (e.g., Quadrature Phase Shift Keying (OPSK), Quadrature Amplitude Modulation (QAM), etc.) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations for the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g., components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

Meanwhile, communications between the UEs 235 and 236 may be performed based on sidelink communication technology (e.g., ProSe communication technology, D2D communication technology). The sidelink communication may be performed based on a one-to-one scheme or a one-to-many scheme. When V2V communication is performed using sidelink communication technology, the UE 235 may refer to a communication node located in the first vehicle 100 of FIG. 1, and the UE 236 may refer to a communication node located in the second vehicle 110 of FIG. 1. When V2I communication is performed using sidelink communication technology, the UE 235 may refer to a communication node located in the first vehicle 100 of FIG. 1, and the UE 236 may refer to a communication node located in the infrastructure 120 of FIG. 1. When V2P communication is performed using sidelink communication technology, the UE 235 may refer to a communication node located in the first vehicle 100 of FIG. 1, and the UE 236 may refer to a communication node carried by the person 130.

The scenarios to which the sidelink communications are applied may be classified as shown below in Table 1 according to the positions of the UEs (e.g., the UEs 235 and 236) participating in the sidelink communications. For example, the scenario for the sidelink communications between the UEs 235 and 236 shown in FIG. 2 may be a sidelink communication scenario C.

TABLE 1

| Sidelink | | |
|---|---|---|
| Communication | Position of UE 235 | Position of UE 236 |
| Scenario | | |
| A | Out of coverage of | Out of coverage of |
| | base station 210 | base station 210 |
| B | In coverage of | Out of coverage of |
| | base station 210 | base station 210 |
| C | In coverage of | In coverage of |
| | base station 210 | base station 210 |
| D | In coverage of | In coverage of other |
| | base station 210 | base station |

Meanwhile, a user plane protocol stack of the UEs (e.g., the UEs 235 and 236) performing sidelink communications may be configured as follows.

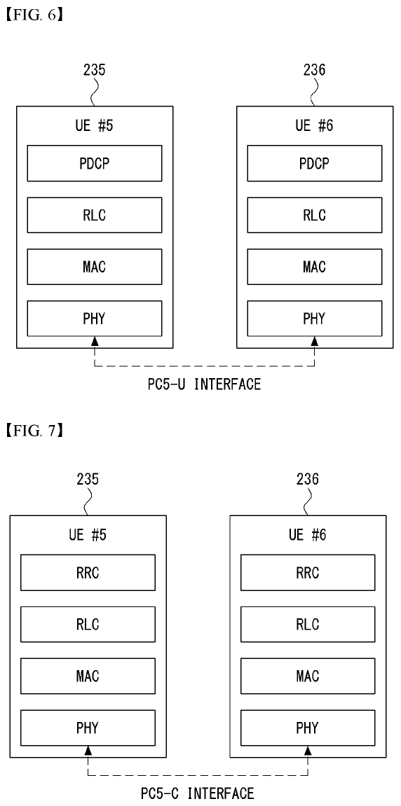

FIG. 6 is a block diagram illustrating a first exemplary embodiment of a user plane protocol stack of a UE performing sidelink communication.

As shown in FIG. 6, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The user plane protocol stack of each of the UEs 235 and 236 may comprise a physical (PHY) layer, a medium access control (MAC) layer, a radio link control (RLC) layer, and a packet data convergence protocol (PDCP) layer.

The sidelink communications between the UEs 235 and 236 may be performed using a PC5 interface (e.g., PC5-U interface). A layer-2 identifier (ID) (e.g., a source layer-2 ID, a destination layer-2 ID) may be used for the sidelink communications, and the layer 2-ID may be an ID configured for the V2X communications. Also, in the sidelink communications, a hybrid automatic repeat request (HARQ) feedback operation may be supported, and an RLC acknowledged mode (RLC AM) or an RLC unacknowledged mode (RLC UM) may be supported.

Meanwhile, a control plane protocol stack of the UEs (e.g., the UEs 235 and 236) performing sidelink communications may be configured as follows.

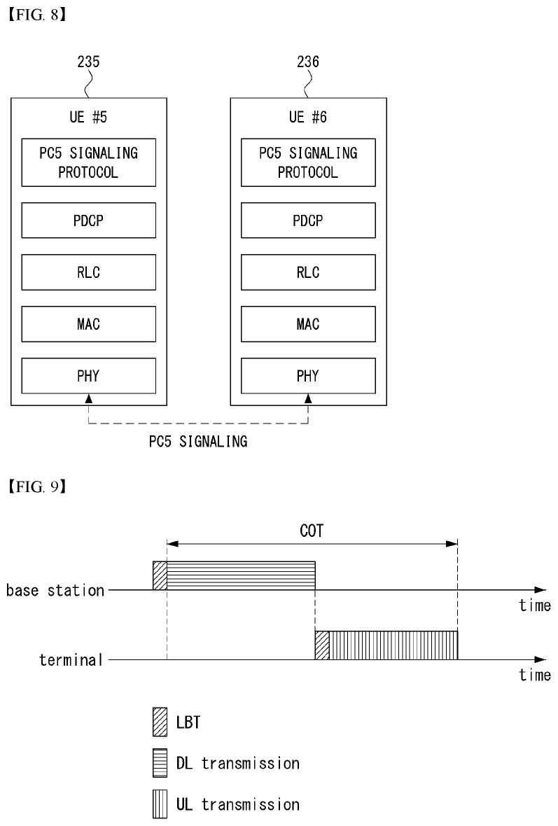

FIG. 7 is a block diagram illustrating a first exemplary embodiment of a control plane protocol stack of a UE performing sidelink communication, and FIG. 8 is a block diagram illustrating a second exemplary embodiment of a control plane protocol stack of a UE performing sidelink communication.

As shown in FIGS. 7 and 8, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The control plane protocol stack illustrated in FIG. 7 may be a control plane protocol stack for transmission and reception of broadcast information (e.g., Physical Sidelink Broadcast Channel (PSBCH)).

The control plane protocol stack shown in FIG. 7 may include a PHY layer, a MAC layer, an RLC layer, and a radio resource control (RRC) layer. The sidelink communications between the UEs 235 and 236 may be performed using a PC5 interface (e.g., PC5-C interface). The control plane protocol stack shown in FIG. 8 may be a control plane protocol stack for one-to-one sidelink communication. The control plane protocol stack shown in FIG. 8 may include a PHY layer, a MAC layer, an RLC layer, a PDCP layer, and a PC5 signaling protocol layer.

Meanwhile, channels used in the sidelink communications between the UEs 235 and 236 may include a Physical Sidelink Shared Channel (PSSCH), a Physical Sidelink Control Channel (PSCCH), a Physical Sidelink Discovery Channel (PSDCH), and a Physical Sidelink Broadcast Channel (PSBCH). The PSSCH may be used for transmitting and receiving sidelink data and may be configured in the UE (e.g., UE 235 or 236) by higher layer signaling. The PSCCH may be used for transmitting and receiving sidelink control information (SCI) and may also be configured in the UE (e.g., UE 235 or 236) by higher layer signaling.

The PSDCH may be used for a discovery procedure. For example, a discovery signal may be transmitted over the PSDCH. The PSBCH may be used for transmitting and receiving broadcast information (e.g., system information). Also, a demodulation reference signal (DM-RS), a synchronization signal, or the like may be used in the sidelink communications between the UEs 235 and 236. The synchronization signal may include a primary sidelink synchronization signal (PSSS) and a secondary sidelink synchronization signal (SSSS).

Meanwhile, a sidelink transmission mode (TM) may be classified into sidelink TMs 1 to 4 as shown below in Table 2.

TABLE 2

| Sidelink TM | Description |
|---|---|
| 1 | Transmission using resources |
| | scheduled by base station |
| 2 | UE autonomous transmission |
| | without scheduling of base station |
| 3 | Transmission using resources scheduled |
| | by base station in V2X communications |
| 4 | UE autonomous transmission without |
| | scheduling of base station in |
| | V2X communications |

When the sidelink TM 3 or 4 is supported, each of the UEs 235 and 236 may perform sidelink communications using a resource pool configured by the base station 210. The resource pool may be configured for each of the sidelink control information and the sidelink data.

The resource pool for the sidelink control information may be configured based on an RRC signaling procedure (e.g., a dedicated RRC signaling procedure, a broadcast RRC signaling procedure). The resource pool used for reception of the sidelink control information may be configured by a broadcast RRC signaling procedure. When the sidelink TM 3 is supported, the resource pool used for transmission of the sidelink control information may be configured by a dedicated RRC signaling procedure. In this case, the sidelink control information may be transmitted through resources scheduled by the base station 210 within the resource pool configured by the dedicated RRC signaling procedure. When the sidelink TM 4 is supported, the resource pool used for transmission of the sidelink control information may be configured by a dedicated RRC signaling procedure or a broadcast RRC signaling procedure. In this case, the sidelink control information may be transmitted through resources selected autonomously by the UE (e.g., UE 235 or 236) within the resource pool configured by the dedicated RRC signaling procedure or the broadcast RRC signaling procedure.

When the sidelink TM 3 is supported, the resource pool for transmitting and receiving sidelink data may not be configured. In this case, the sidelink data may be transmitted and received through resources scheduled by the base station 210. When the sidelink TM 4 is supported, the resource pool for transmitting and receiving sidelink data may be configured by a dedicated RRC signaling procedure or a broadcast RRC signaling procedure. In this case, the sidelink data may be transmitted and received through resources selected autonomously by the UE (e.g., UE 235 or 236) within the resource pool configured by the dedicated RRC signaling procedure or the broadcast RRC signaling procedure.

Hereinafter, sidelink communication methods will be described. Even when a method (e.g., transmission or reception of a signal) to be performed at a first communication node among communication nodes is described, a corresponding second communication node may perform a method (e.g., reception or transmission of the signal) corresponding to the method performed at the first communication node. That is, when an operation of a UE #1 (e.g., vehicle #1) is described, a UE #2 (e.g., vehicle #2) corresponding thereto may perform an operation corresponding to the operation of the UE #1. Conversely, when an operation of the UE #2 is described, the corresponding UE #1 may perform an operation corresponding to the operation of the UE #2. In exemplary embodiments described below, an operation of a vehicle may be an operation of a communication node located in the vehicle.

A sidelink signal may be a synchronization signal and a reference signal used for sidelink communication. For example, the synchronization signal may be a synchronization signal/physical broadcast channel (SS/PBCH) block, sidelink synchronization signal (SLSS), primary sidelink synchronization signal (PSSS), secondary sidelink synchronization signal (SSSS), or the like. The reference signal may be a channel state information-reference signal (CSI-RS), DM-RS, phase tracking-reference signal (PT-RS), cell-specific reference signal (CRS), sounding reference signal (SRS), discovery reference signal (DRS), or the like.

A sidelink channel may be a PSSCH, PSCCH, PSDCH, PSBCH, physical sidelink feedback channel (PSFCH), or the like. In addition, a sidelink channel may refer to a sidelink channel including a sidelink signal mapped to specific resources in the corresponding sidelink channel. The sidelink communication may support a broadcast service, a multicast service, a groupcast service, and a unicast service.

The base station may transmit system information (e.g., SIB12, SIB13, SIB14) and RRC messages including configuration information for sidelink communication (i.e., sidelink configuration information) to UE(s). The UE may receive the system information and RRC messages from the base station, identify the sidelink configuration information included in the system information and RRC messages, and perform sidelink communication based on the sidelink configuration information. The SIB12 may include sidelink communication/discovery configuration information. The SIB13 and SIB14 may include configuration information for V2X sidelink communication.

The sidelink communication may be performed within a SL bandwidth part (BWP). The base station may configure SL BWP(s) to the UE using higher layer signaling. The higher layer signaling may include SL-BWP-Config and/or SL-BWP-ConfigCommon. SL-BWP-Config may be used to configure a SL BWP for UE-specific sidelink communication. SL-BWP-ConfigCommon may be used to configure cell-specific configuration information.

Furthermore, the base station may configure resource pool(s) to the UE using higher layer signaling. The higher layer signaling may include SL-BWP-PoolConfig, SL-BWP-PoolConfigCommon, SL-BWP-DiscPoolConfig, and/or SL-BWP-DiscPoolConfigCommon. SL-BWP-PoolConfig may be used to configure a sidelink communication resource pool. SL-BWP-PoolConfigCommon may be used to configure a cell-specific sidelink communication resource pool. SL-BWP-DiscPoolConfig may be used to configure a resource pool dedicated to UE-specific sidelink discovery. SL-BWP-DiscPoolConfigCommon may be used to configure a resource pool dedicated to cell-specific sidelink discovery. The UE may perform sidelink communication within the resource pool configured by the base station.

The sidelink communication may support SL discontinuous reception (DRX) operations. The base station may transmit a higher layer message (e.g., SL-DRX-Config) including SL DRX-related parameter(s) to the UE. The UE may perform SL DRX operations based on SL-DRX-Config received from the base station. The sidelink communication may support inter-UE coordination operations. The base station may transmit a higher layer message (e.g., SL-InterUE-CoordinationConfig) including inter-UE coordination parameter(s) to the UE. The UE may perform inter-UE coordination operations based on SL-Inter UE-CoordinationConfig received from the base station.

The sidelink communication may be performed based on a single-SCI scheme or a multi-SCI scheme. When the single-SCI scheme is used, data transmission (e.g., sidelink data transmission, sidelink-shared channel (SL-SCH) transmission) may be performed based on one SCI (e.g., 1st-stage SCI). When the multi-SCI scheme is used, data transmission may be performed using two SCIs (e.g., 1st-stage SCI and 2nd-stage SCI). The SCI(s) may be transmitted on a PSCCH and/or a PSSCH. When the single-SCI scheme is used, the SCI (e.g., 1st-stage SCI) may be transmitted on a PSCCH. When the multi-SCI scheme is used, the 1st-stage SCI may be transmitted on a PSCCH, and the 2nd-stage SCI may be transmitted on the PSCCH or a PSSCH. The 1st-stage SCI may be referred to as ‘first-stage SCI’, and the 2nd-stage SCI may be referred to as ‘second-stage SCI’. A format of the first-stage SCI may include a SCI format 1-A, and a format of the second-stage SCI may include a SCI format 2-A, a SCI format 2-B, and a SCI format 2-C.

The SCI format 1-A may be used for scheduling a PSSCH and second-stage SCI. The SCI format 1-A may include at least one among priority information, frequency resource assignment information, time resource assignment information, resource reservation period information, demodulation reference signal (DMRS) pattern information, second-stage SCI format information, beta_offset indicator, number of DMRS ports, modulation and coding scheme (MCS) information, additional MCS table indicator, PSFCH overhead indicator, or conflict information receiver flag.

The SCI format 2-A may be used for decoding of a PSSCH. The SCI format 2-A may include at least one among a HARQ processor number, new data indicator (NDI), redundancy version (RV), source ID, destination ID, HARQ feedback enable/disable indicator, cast type indicator, or CSI request.

The SCI format 2-B may be used for decoding of a PSSCH. The SCI format 2-B may include at least one among a HARQ processor number, NDI, RV, source ID, destination ID, HARQ feedback enable/disable indicator, zone ID, or communication range requirement.

The SCI format 2-C may be used for decoding of a PSSCH. In addition, the SCI format 2-C may be used to provide or request inter-UE coordination information. The SCI format 2-C may include at least one among a HARQ processor number, NDI, RV, source ID, destination ID, HARQ feedback enable/disable indicator, CSI request, or providing/requesting indicator.

When a value of the providing/requesting indicator is set to 0, this may indicate that the SCI format 2-C is used to provide inter-UE coordination information. In this case, the SCI format 2-C may include at least one among resource combinations, first resource location, reference slot location, resource set type, or lowest subchannel indexes.

When a value of the providing/requesting indicator is set to 1, this may indicate that the SCI format 2-C is used to request inter-UE coordination information. In this case, the SCI format 2-C may include at least one among a priority, number of subchannels, resource reservation period, resource selection window location, resource set type, or padding bit(s).

Meanwhile, sidelink communication may be performed in a licensed band and/or an unlicensed band. Sidelink communication performed in an unlicensed band may be referred to as sidelink-unlicensed band (SL-U) communication or unlicensed band-sidelink (U-SL) communication. In SL-U communication, a first terminal may communicate with a second terminal according to a mode 1 or mode 2. When the mode 1 is used, the first terminal may communicate with the second terminal based on scheduling by a base station. When the mode 2 is used, the first terminal may communicate with the second terminal without scheduling by a base station. The mode 1 may correspond to the sidelink TM #1 or #3 disclosed in Table 2 above. The mode 2 may correspond to the sidelink TM #2 or #4 disclosed in Table 2 above.

FIG. 9 is a timing diagram illustrating a first exemplary embodiment of a communication method in an unlicensed band.

As shown in FIG. 9, a base station may perform a listen-before-talk (LBT) operation to perform downlink (DL) transmission, and if a result of the LBT operation indicates an idle state (e.g., clean state) of a channel, the base station may perform DL transmission. A terminal may perform an LBT operation to perform uplink (UL) transmission, and if a result of the LBT operation indicates an idle state of a channel, the terminal may perform UL transmission. If the result of the LBT operation indicates a busy state of the channel, the DL transmission and/or UL transmission may not be performed. The DL transmission and/or UL transmission may be performed within a channel occupancy time (COT). The COT may be initiated by the base station or terminal. The LBT operations may be performed based on one of categories disclosed in Table 3 below.

TABLE 3

| | Description |
|---|---|
| Category 1 | The transmission operation is performed |
| (Cat 1 LBT) | after a short switching gap of 16 us. |
| | The CCA operation is not performed. |
| Category 2 | The LBT operation is performed within |
| (Cat 2 LBT) | a fixed CCA period (e.g., 25 us) |
| | without a random backoff operation. |
| Category 3 | The LBT operation is performed |
| (Cat 3 LBT) | based on a random backoff |
| | operation and a variable CCA period. |
| | The size of contention window is fixed. |
| Category 4 | The LBT operation is performed |
| (Cat 4 LBT) | based on a random backoff |
| | operation and a variable CCA period. |
| | The size of contention window is variable. |

The LBT operation may refer to a clear channel assessment (CCA) operation. The CCA operation may be performed during a CCA period. When the CCA operation is performed, the communication node (e.g., base station and/or terminal) may identify a channel state based on an energy detection (ED) scheme. In other words, the communication node may determine whether another signal exists in the channel. If an energy detected during the CCA period is less than a threshold (e.g., ED threshold), the communication node may determine the channel state as the idle state. In other words, the communication node may determine that no other signals exist in the channel. If the channel state is determined as the idle state, the communication node may access the channel within the COT. If the energy detected during the CCA period is equal to or above the threshold, the communication node may determine the channel state as the busy state. In other words, the communication node may determine that another signal exists in the channel. If the channel state is the busy state, the communication node may not access the channel within the COT.

In an unlicensed band, the communication node may perform the LBT operation and transmit data when a result of the LBT operation indicates the idle state of the channel. In this case, the base station may transmit a DL transmission burst within the COT, and the terminal may transmit a UL transmission burst within the COT. The COT may be configured within a maximum COT (MCOT). A slot duration of CCA may be 5 μs~9 μs. The duration of the MCOT may be 8 ms. The base station may initiate and/or configure a COT based on a higher layer parameter SemiStaticChannelAccessConfig. SemiStaticChannelAccessConfig may include information on a period of the COT. The terminal may identify the COT initiated by the base station based on SemiStaticChannelAccessConfig.

The terminal may initiate and/or configure a COT based on a higher layer parameter SemiStaticChannelAccessConfigUE. SemiStaticChannelAccessConfigUE may include information on a period and an offset of the COT. The base station may identify the COT initiated by the terminal based on SemiStaticChannelAccessConfigUE.

The terminal may initiate and/or configure the COT based on SemiStaticChannelAccessConfigUE in the unlicensed band. As another method, the base station may signal SemiStaticChannelAccessConfigSL-U for a COT of SL-U communication to the terminal. The COT for SL-U communication may be referred to as a sidelink (SL)-COT. SemiStaticChannelAccessConfigSL-U may include information on a period and an offset of the SL-COT. The terminal may configure the SL-COT based on SemiStaticChannelAccessConfig-U. Other terminals may identify the COT initiated based on SemiStaticChannelAccessConfigSL-U.

In an unlicensed band, the terminal may perform an LBT operation before SL communication (e.g., transmission of SL data) in order to perform the SL communication. If the LBT operation succeeds, a COT may be initiated in the unlicensed band, and the SL communication may be performed within the COT. ‘The LBT operation succeeds’ may mean that a result of the LBT operation indicates an idle state.

In an unlicensed band, a channel access procedure may be classified into a DL channel access procedure and a UL channel access procedure. The DL channel access procedure may be classified into a Type 1 DL channel access procedure and a Type 2 DL channel access procedure. The Type 1 DL channel access procedure may be performed for initiation of a COT. The Type 2 DL channel access procedure may be performed for transmission within a COT (e.g., shared COT). The channel access procedure may refer to an LBT operation. The Type 1 DL channel access procedure may be performed for at least one of physical downlink shared channel (PDSCH) transmission, physical downlink control channel (PDCCH) transmission, or enhanced PDCCH (EPDCCH) transmission initiated by an eNB and/or any transmission initiated by a gNB. The eNB may refer to a base station in a 4G communication system, and the gNB may refer to a base station in a 5G communication system.

The Type 2 DL channel access procedure may be performed for at least one of discovery burst transmission or transmission not including a PDSCH initiated by an eNB and/or discovery burst transmission or discovery transmission multiplexed with non-unicast information initiated by a gNB. The Type 2 DL channel access procedure may be classified into a Type 2A DL channel access procedure, a Type 2B DL channel access procedure, and a Type 2C DL channel access procedure. The lengths of sensing periods (e.g., sensing intervals) in the Type 2A DL channel access procedure, Type 2B DL channel access procedure, and Type 2C DL channel access procedure may be different. The length of the sensing period in the Type 2A DL channel access procedure may be 25 μs. The length of the sensing period in the Type 2B DL channel access procedure may be 16 μs. Sensing operations may not be performed in the Type 2C DL channel access procedure.

The UL channel access procedure may be classified into a Type 1 UL channel access procedure and a Type 2 UL channel access procedure. The Type 1 UL channel access procedure may be performed for initiation of a COT. The Type 2 UL channel access procedure may be performed for transmission within a COT (e.g., shared COT). The Type 1 UL channel access procedure may be performed for at least one of physical uplink shared channel (PUSCH) transmission or sounding reference signal (SRS) transmission scheduled or configured by an eNB, at least one of PUSCH transmission or SRS transmission scheduled or configured by a gNB, PUCCH transmission scheduled or configured by a gNB, and/or transmission related to a random access (RA) procedure.

The Type 2 UL channel access procedure may be classified into a Type 2A UL channel access procedure, a Type 2B UL channel access procedure, and a Type 2C UL channel access procedure. The lengths of sensing periods for the Type 2A UL channel access procedure and Type 2B UL channel access procedure may be different. The length of the sensing period in the Type 2A UL channel access procedure may be 25 μs. The length of the sensing period in the Type 2B UL channel access procedure may be 16 μs. Sensing operations may not be performed in the Type 2C UL channel access procedure.

The Type 1 DL channel access procedure, Type 2 DL channel access procedure, Type 1 UL channel access procedure, and/or Type 2 UL channel access procedure may be used for SL-U communication. In this case, in description on the Type 1 DL channel access procedure, Type 2 DL channel access procedure, Type 1 UL channel access procedure, and/or Type 2 UL channel access procedure, a downlink channel and/or uplink channel may be interpreted as a sidelink channel. The LBT operation may be interpreted as the Type 1 DL channel access procedure, Type 2 DL channel access procedure, new Type DL channel access procedure, Type 1 UL channel access procedure, Type 2 UL channel access procedure, and/or new Type UL channel access procedure.

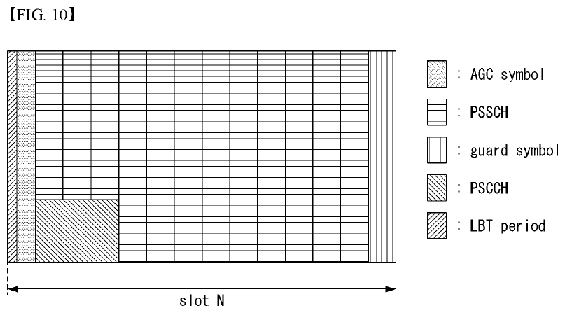

FIG. 10 is a conceptual diagram illustrating a first exemplary embodiment of an LBT operation in SL-U communication.

As shown in FIG. 10, in SL-U communication, a communication node (e.g., base station, terminal) may perform an LBT operation before transmission. An automatic gain control (AGC) operation may be required for transmission and reception of SL data. The first symbol of a slot N may be used for the AGC operation. Therefore, the LBT operation may be performed before the start of the AGC operation in SL-U communication. The symbol used for the AGC operation may be referred to as an AGC symbol. The communication node may perform transmission (e.g., data transmission) after performing the LBT operation and AGC operation. The LBT operation and AGC operation may be performed in the first symbol of the slot N.

FIG. 11 is a conceptual diagram illustrating a second exemplary embodiment of an LBT operation in SL-U communication.

As shown in FIG. 11, the LBT operation may be performed before the start of the AGC operation. The LBT operation may be performed in the last symbol (e.g., guard symbol) of a slot N−1 or performed in the last symbol of the slot N−1 and the first symbol of the symbol N (e.g., AGC symbol). The communication node may perform transmission (e.g., data transmission) after performing the LBT operation and AGC operation. In exemplary embodiment(s) of the present disclosure, the LBT operation may be assumed to be performed in the manner illustrated in FIG. 11. Alternatively, the LBT operation may be assumed to be performed in a manner other than the manner illustrated in FIG. 11.

In SL-U communication, the communication node may fail the LBT operation. In this case, the communication node may perform the LBT operation in the next slot, and may perform transmission (e.g., data transmission) if the LBT operation succeeds. If the LBT operation fails, a transmission delay may occur. When the LBT operation is performed on a slot basis, the transmission delay may occur on a slot basis. To reduce the transmission delay and/or prepare for the LBT failure, transmission (e.g., data transmission) may be initiated at one among one or more symbols (e.g., all symbols) within a slot. The one or more symbols at which transmission can be initiated may not include the first symbol within the slot. The symbol at which transmission is initiated may refer to the symbol at which the LBT operation is performed. Alternatively, the LBT operation may be performed in a symbol preceding the symbol at which transmission is initiated.

The symbol at which the LBT operation is performed may be referred to as an LBT symbol. One or more LBT symbols may be configured within a slot. For example, a base station may configure LBT symbols to a terminal. Alternatively, a transmitting terminal may configure LBT symbols to a receiving terminal. The first symbol and other symbol(s) other than the first symbol within the slot may be configured as LBT symbols. The LBT symbol may mean a starting point. In other words, the LBT symbol may mean a starting point for transmission of a channel (e.g., PSCCH, PSSCH, PSFCH). The LBT symbol and the starting point may be configured as the same symbol. Alternatively, the LBT symbol may be located before the starting point. In this case, if the LBT operation succeeds in the LBT symbol, the terminal may perform data transmission at the starting point.

If there is one LBT symbol within a slot, the first symbol may be configured as an LBT symbol. If there are two LBT symbols in a slot, the first symbol and the eighth symbol or the first symbol and the eleventh symbol may be configured as LBT symbols. If there are three LBT symbols in a slot, the first symbol, the sixth symbol, and the eleventh symbol may be configured as LBT symbols. In the present disclosure, the first symbol in the slot may be referred to as a symbol 0, the sixth symbol in the slot may be referred to as a symbol 5, the eighth symbol in the slot may be referred to as a symbol 7, and the eleventh symbol in the slot may be referred to as a symbol 10.

The position of PSSCH DM-RS in the time domain may be defined as shown in Table 4 below. The PSSCH DM-RS may be a DM-RS used for modulation and/or demodulation of a PSSCH. Referring to Table 4, the minimum number of symbols required for transmission of SL data may be 6 symbols. The 6 symbols may include at least an AGC symbol.

TABLE 4

| | PSSCH DM-RS position | | | | | |
|---|---|---|---|---|---|---|
| Length of scheduled | PSCCH duration: 2 symbols | | | PSCCH duration: 3 symbols | | |
| resource (number | Number of PSSCH DM-RS | | | Number of PSSCH DM-RS | | |
| of symbols) | 2 | 3 | 4 | 2 | 3 | 4 |
| 6 | 1, 5 | | | 1, 5 | | |
| 7 | 1, 5 | | | 1, 5 | | |
| 8 | 1, 5 | | | 1, 5 | | |
| 9 | 3, 8 | 1, 4, 7 | | 4, 8 | 1, 4, 7 | |
| 10 | 3, 8 | 1, 4, 7 | | 4, 8 | 1, 4, 7 | |
| 11 | 3, 10 | 1, 5, 9 | 1, 4, 7, 10 | 4, 10 | 1, 5, 9 | 1, 4, 7, 10 |
| 12 | 3, 10 | 1, 5, 9 | 1, 4, 7, 10 | 4, 10 | 1, 5, 9 | 1, 4, 7, 10 |
| 13 | 3, 10 | 1, 6, 11 | 1, 4, 7, 10 | 4, 10 | 1, 6, 11 | 1, 4, 7, 10 |

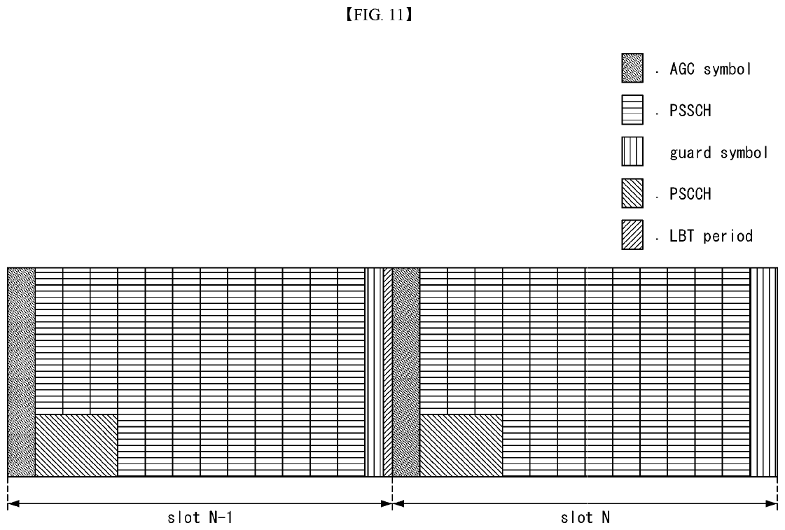

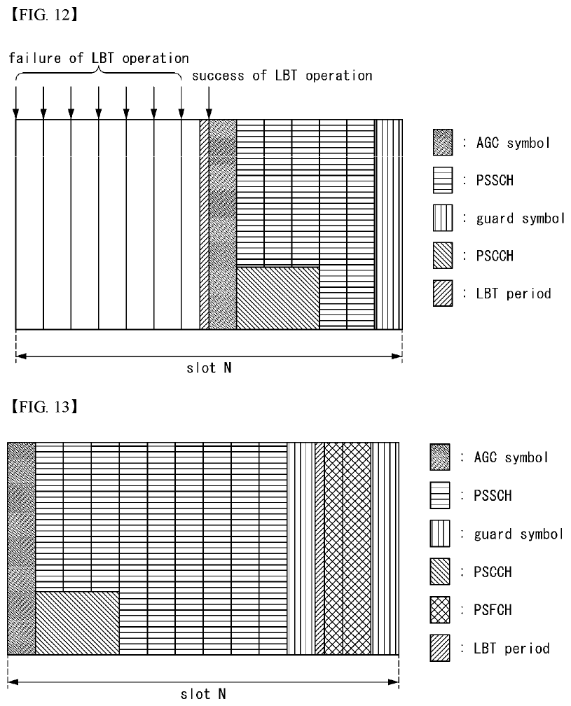

FIG. 12 is a conceptual diagram illustrating a third exemplary embodiment of an LBT operation in SL-U communication.

As shown in FIG. 12, LBT symbol(s) (e.g., the last LBT symbol) may be located before a symbol 7 (e.g., the eighth symbol) within a slot. In other words, no LBT symbol may exist after a symbol 8 within the slot. The symbols 0 to 7 within the slot may be configured as LBT symbols, and an LBT operation may be performed in the symbols 0 to 7.

The LBT symbol(s) may be configured (e.g., preconfigured) for each resource pool. The LBT symbol(s) may be configured in terminal(s) through signaling. Configuration information of LBT symbol(s) may be included in at least one of a PHY signaling message (e.g., first-stage SCI and/or second-stage SCI) or a higher layer signaling message (e.g., RRC message). The configuration information of LBT symbol(s) may include at least one of a symbol index for each of the LBT symbol(s), an index of the first LBT symbol among the LBT symbol(s), an index of a reference LBT symbol among the LBT symbol(s), an index of the last LBT symbol among the LBT symbol(s), the number of the LBT symbol(s), a symbol offset between the first LBT symbol and the last LBT symbol among the LBT symbol(s), a configuration periodicity of the LBT symbol(s), or a bitmap indicating the LBT symbol(s).

PSFCH symbol(s) (e.g., PSFCH resource) for transmitting feedback information (e.g., HARQ-acknowledgement (ACK) information) may be configured within a slot. A slot including PSFCH symbol(s) may be referred to as a PSFCH slot. Two consecutive symbols may be used for transmitting feedback information. The first symbol of the two consecutive symbols may be used for an AGC operation. The AGC operation may be performed in a portion of the first symbol, and the remaining portion of the first symbol may be used for transmitting feedback information. A guard symbol may be required before the first symbol in which the AGC operation is performed. In order to transmit feedback information in SL-U communication, an LBT operation may be performed before the AGC operation. The terminal may transmit the feedback information after performing the LBT operation and AGC operation.

FIG. 13 is a conceptual diagram illustrating a fourth exemplary embodiment of an LBT operation in SL-U communication.

As shown in FIG. 13, the terminal may perform the LBT operation and AGC operation in the symbol 11 within the slot N, and transmit HARQ-ACK information after performing the LBT operation and AGC operation.

FIG. 14 is a conceptual diagram illustrating a fifth exemplary embodiment of an LBT operation in SL-U communication.

As shown in FIG. 14, the terminal may perform the LBT operation in the symbol 10 within the slot N. Alternatively, the terminal may perform the LBT operation in the symbol 10 and symbol 11 within the slot N. In other words, the LBT operation may be performed in a guard symbol. The terminal may perform the AGC operation after performing the LBT operation. The terminal may transmit HARQ-ACK information after performing the LBT operation and AGC operation. In exemplary embodiment(s) of the present disclosure, the LBT operation may be assumed to be performed in the manner illustrated in FIG. 14. Alternatively, the LBT operation may be performed in a different symbol, differently from the manner illustrated in FIG. 14.

In SL-U communication, the terminal may perform the LBT operation for transmitting HARQ-ACK information, and the LBT operation may fail. In this case, the terminal may perform the LBT operation in the next slot (e.g., the next PSFCH slot), and transmit the HARQ-ACK information if the LBT operation succeeds. The PSFCH slot (e.g., PSFCH symbols or PSFCH resource) may be configured periodically. For example, a configuration periodicity of the PSFCH slot (e.g., PSFCH symbols or PSFCH resource) may be 4 slots. In this case, if the LBT operation for transmitting HARQ-ACK information fails, a transmission delay of the HARQ-ACK information may occur. Considering the configuration periodicity of the PSFCH slot, the transmission delay of HARQ-ACK information may be longer than a transmission delay of data. In order to prevent the transmission delay of HARQ-ACK information and/or to prepare for a failure of the LBT operation, a plurality of LBT symbols may be configured within the PSFCH slot. In this case, if the LBT operation fails in the first LBT symbol within a first PSFCH slot, the terminal may perform the LBT operation again in the second LBT symbol following the first LBT symbol within the first PSFCH slot.

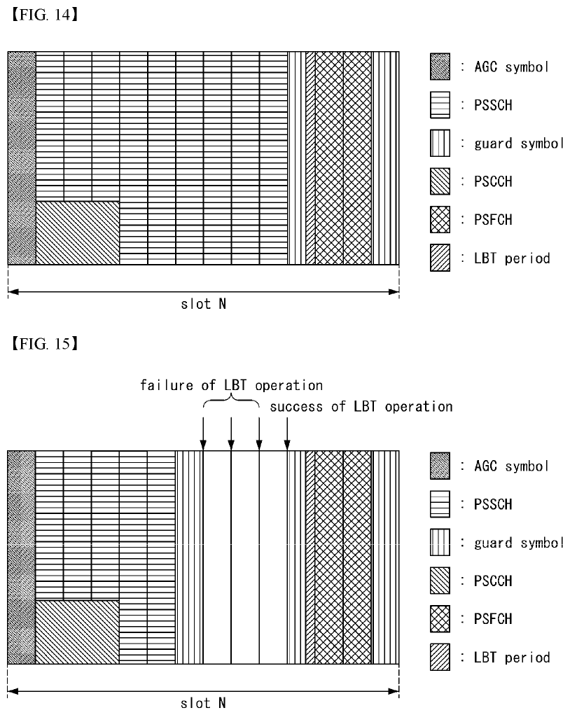

FIG. 15 is a conceptual diagram illustrating a sixth exemplary embodiment of an LBT operation in SL-U communication.

As shown in FIG. 15, the symbols 7 to 10 within the PSFCH slot may be configured as LBT symbols. Referring to Table 4, the minimum number of symbols required for transmission of SL data may be 6 symbols, and the 6 symbols may include at least an AGC symbol. Therefore, the LBT symbols may be configured from the symbol 7 within the PSFCH slot. The position of the first LBT symbol among the plurality of LBT symbols configured within the PSFCH slot may be determined by considering the number of symbols scheduled for PSSCH and/or PSCCH transmission. For example, if the number K of symbols scheduled for PSSCH and/or PSCCH transmission is 6, the first LBT symbol among the plurality of LBT symbols may be the symbol (K+1) (e.g., symbol 7). In the exemplary embodiment of FIG. 15, it may be assumed that all symbols included in the PSFCH slot are LBT symbols.

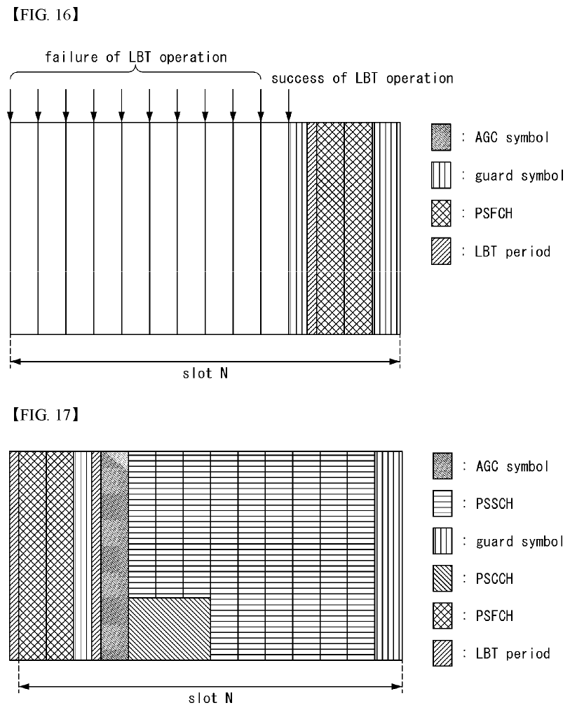

FIG. 16 is a conceptual diagram illustrating a seventh exemplary embodiment of an LBT operation in SL-U communication.

As shown in FIG. 16, in order to improve a possibility of transmitting HARQ-ACK information within a PSFCH slot, data transmission may not be performed within the PSFCH slot. In other words, a PSSCH and/or a PSCCH may not be configured within the PSFCH slot. In this case, LBT symbol(s) may exist from the symbol 0 within the PSFCH slot. For example, the first LBT symbol among a plurality of LBT symbols may be the symbol 0 within the PSFCH slot, and the last LBT symbol among the plurality of LBT symbols may be the symbol 10 within the PSFCH slot. In other words, the last LBT symbol among the plurality of LBT symbols may be located before the symbol 11 within the PSFCH slot. In the exemplary embodiment of FIG. 16, it may be assumed that all symbols included in the PSFCH slot are LBT symbols.

FIG. 17 is a conceptual diagram illustrating an eighth exemplary embodiment of an LBT operation in SL-U communication.

As shown in FIG. 17, the LBT operation for transmitting HARQ-ACK information may be performed from the symbol 0 within the PSFCH slot. In other words, the symbol 0 within the PSFCH slot may be configured as an LBT symbol. Alternatively, the LBT operation for transmitting HARQ-ACK information may be performed in a previous symbol of the PSFCH slot. Two or more symbols may be configured as LBT symbols. The terminal may perform the LBT operation in the symbol 0 of the slot N or a previous symbol of the symbol 0 (e.g., symbol 13 of the symbol N−1), and if the LBT operation succeeds, the terminal may transmit the HARQ-ACK information in the symbols 0 and 1 of the slot N. After transmitting the HARQ-ACK information, the terminal may perform data transmission and reception operations using the remaining symbols.

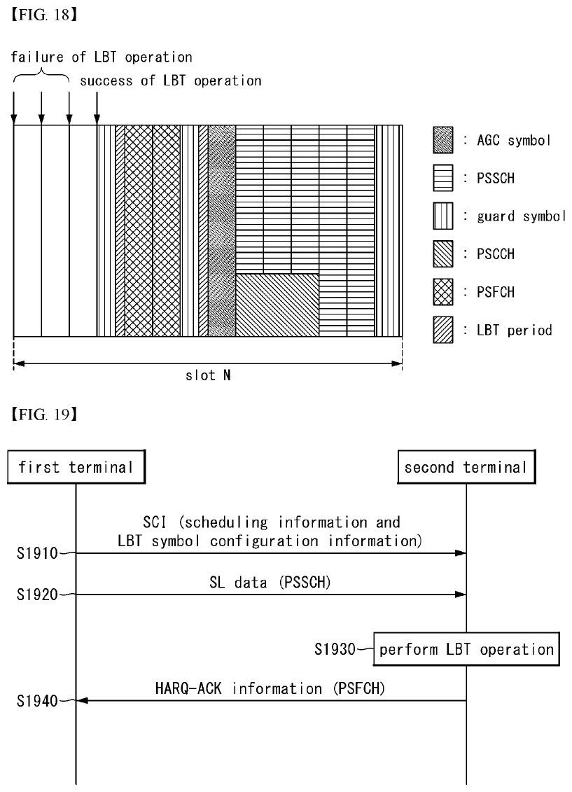

FIG. 18 is a conceptual diagram illustrating a ninth exemplary embodiment of an LBT operation in SL-U communication.

As shown in FIG. 18, a plurality of LBT symbols (e.g., the number and/or positions of the plurality of LBT symbols) may be configured considering the minimum number (e.g., 6) of symbols required for transmission of SL data in Table 4. For example, the last LBT symbol among the plurality of LBT symbols may be located before the symbol 4. In the exemplary embodiment of FIG. 18, it may be assumed that all symbols included in the PSFCH slot are LBT symbols.

The LBT operation may be possible in the LBT symbol. The LBT symbol(s) may be configured (e.g., preconfigured) for each resource pool. The LBT symbol(s) may be configured to the terminal(s) through signaling. The configuration information of LBT symbol(s) may be included in at least one of a PHY signaling message (e.g., first-stage SCI and/or second-stage SCI) or a higher layer signaling message (e.g., RRC message). The configuration information of LBT symbol(s) may include at least one of a symbol index for each of the LBT symbol(s), an index of the first LBT symbol among the LBT symbol(s), an index of a reference LBT symbol among the LBT symbol(s), an index of the last LBT symbol among the LBT symbol(s), the number of the LBT symbol(s), a symbol offset between the first LBT symbol and the last LBT symbol among the LBT symbol(s), a configuration periodicity of the LBT symbol(s), or a bitmap indicating the LBT symbol(s).

The configuration information of the LBT symbol(s) (e.g., the LBT symbol(s)) may be configured in consideration of existence of a PSFCH slot and/or a periodicity of the PSFCH slot. When the periodicity of the PSFCH slot is 4 slots, the symbols 0 to 11 with the PSFCH slot may be configured as LBT symbols. In this case, the terminal may perform the LBT operation in the symbols 0 to 11 within the PSFCH slot. When the periodicity of the PSFCH slot is 1 slot, the symbols 0 to 4 within the PSFCH slot may be configured as LBT symbols. In this case, the terminal may perform the LBT operation in the symbols 0 to 4 within the PSFCH slot. In other words, when the periodicity of the PSFCH slot is short, the number of LBT symbols within the PSFCH slot may be relatively small. When the periodicity of the PSFCH slot is long, the number of LBT symbols within the PSFCH slot may be relatively large.

In the time domain, the LBT symbols may be configured as multiple symbols within the PSFCH slot. In SL-U communication, a slot may have a flexible structure. At least one LBT symbol among one or more LBT symbols for PSCCH transmission, one or more LBT symbols for PSSCH transmission, or one or more LBT symbols for PSFCH transmission may be configured within one slot. A time resource and/or frequency resource of a PSFCH slot in 3GPP release 17 may be different from a time resource and/or frequency resource of a PSFCH slot in releases prior to the 3GPP release 17.

A PSFCH resource for PSSCH transmission using the same starting subchannel in the same slot may be indicated by an SCI (e.g., SCI scheduling the PSCCH transmission). In other words, the terminal may select a PSFCH resource based on information element(s) included in the SCI.

A physical resource block (PRB) set for a candidate PSFCH resource may be determined by a starting subchannel and slot for a PSSCH associated with the candidate PSFCH resource. The above-described operation may be defined as Scheme 1. A PRB set for a candidate PSFCH resource may be determined by a starting subchannel(s) and slot for a PSSCH associated with the candidate PSFCH resource. The above-described operation may be defined as Scheme 2. Information indicating Scheme 1 or Scheme 2 may be signaled to terminal(s). One of the schemes may be configured (e.g., preconfigured) for each resource pool. For example, Scheme 1 may be configured for a resource pool 1, and Scheme 2 may be configured for a resource pool 2.

In order to satisfy occupied channel bandwidth (OCB) requirements in SL-U communication, interlace RB-based transmission for a PSCCH and/or PSSCH may be supported. In addition, interlace RB-based transmission for a PSFCH may be supported to satisfy the OCB requirements. If interlace RB-based transmission for a PSFCH is supported, a PRB set for a candidate PSFCH resource (e.g., candidate PSFCH resource in all resource pools) may be determined by at least one of a starting subchannel or slot for a PSSCH associated with the candidate PSFCH resource. Alternatively, interlace RB-based transmission for a PSFCH may not be supported. In this case, the OCB may be set to 80% or less.

FIG. 19 is a sequence chart illustrating a first exemplary embodiment of an SL-U communication method.

As shown in FIG. 19, a first terminal may be a transmitting terminal that transmits data (e.g., SL data), and a second terminal may be a receiving terminal that receives the data. The first terminal may generate an SCI including scheduling information of the data (e.g., PSSCH) and configuration information of LBT symbol(s). The LBT symbol may be a symbol in which an LBT operation is performed. The configuration information of LBT symbol(s) may indicate one or more LBT symbols that are configured within one slot (e.g., one PSFCH slot). The configuration information of LBT symbol(s) may include at least one of a symbol index for each of the LBT symbol(s), an index of the first LBT symbol among the LBT symbol(s), an index of a reference LBT symbol among the LBT symbol(s), an index of the last LBT symbol among the LBT symbol(s), the number of the LBT symbol(s), a symbol offset between the first LBT symbol and the last LBT symbol among the LBT symbol(s), a configuration periodicity of the LBT symbol(s), or a bitmap indicating the LBT symbol(s).

The first terminal may transmit the SCI to the second terminal (S1910). The second terminal may receive the SCI from the first terminal and identify information element(s) included in the SCI. For example, the second terminal may identify the scheduling information of the data and the configuration information of LBT symbol(s) included in the SCI. Alternatively, the first terminal may transmit the configuration information of LBT symbol(s) to the second terminal using another signaling message (e.g., RRC signaling message, MAC signaling message, PHY signaling message) instead of the SCI (e.g., SCI including the scheduling information of the data). In other words, the scheduling information of the data may be transmitted through the SCI, and the configuration information of LBT symbol(s) may be transmitted through a signaling message other than the SCI. As another method, the base station may inform the terminal(s) (e.g., the first terminal and/or the second terminal) of the configuration information of LBT symbol(s) using a signaling message. In other words, the configuration information of LBT symbol(s) may be signaled by the base station instead of the first terminal.

The second terminal may obtain the configuration information of LBT symbol(s) based on the above method(s). The second terminal may identify the LBT symbol(s) in which an LBT operation for transmitting HARQ-ACK information (e.g., feedback information, PSFCH) is performed based on the configuration information of LBT symbol(s). In other words, the second terminal may identify position(s) of the LBT symbol(s) within the slot (e.g., PSFCH slot).

The first terminal may transmit the data (e.g., PSSCH) scheduled by the SCI to the second terminal (S1920). The second terminal may receive the data from the first terminal based on the scheduling information included in the SCI. The second terminal may perform the LBT operation for transmitting HARQ-ACK information (e.g., ACK or negative ACK (NACK)) for the data (S1930). The LBT operation may be performed in the LBT symbol(s) identified based on the configuration information. The LBT symbol(s) may be configured within a PSFCH slot, and the PSFCH slot may be configured periodically. The second terminal may perform the LBT operation based on at least one of the exemplary embodiments illustrated in FIGS. 13 to 18.

A plurality of LBT symbols (e.g., first LBT symbol and second LBT symbol) may be configured within one PSFCH slot. The second terminal may perform an LBT operation in the first LBT symbol, and if the LBT operation succeeds, the second terminal may transmit HARQ-ACK information to the first terminal (S1940). If the LBT operation fails in the first LBT symbol, the second terminal may perform an LBT operation in the second LBT symbol following the first LBT symbol. If the LBT operation succeeds in the second LBT symbol, the second terminal may transmit the HARQ-ACK information to the first terminal (S1940). If the LBT operation fails in all LBT symbols within one PSFCH slot, the second terminal may perform an LBT operation in LBT symbol(s) within the next PSFCH slot according to the PSFCH periodicity.

The first terminal may receive the HARQ-ACK information from the second terminal. If the HARQ-ACK information indicates ACK, the first terminal may determine that the data has been successfully received by the second terminal. If the HARQ-ACK information indicates NACK, the first terminal may determine that the data has failed to be received by the second terminal. In this case, the first terminal may retransmit the data.

Meanwhile, if the minimum number of symbols required for transmission of SL data is 5 symbols or less, the above-described exemplary embodiments may be applied in the same or similar manner. At least one of a DM-RS, PT-RS, CSI-RS, or PSCCH may not be transmitted in a symbol configured for the LBT operation, a symbol in which the LBT operation succeeds, and/or a symbol in which the LBT operation fails.

When a subcarrier spacing (SCS) is 15 kHz, an LBT period may be configured within one symbol considering a CCA slot duration. The LBT period may be a period in which the LBT operation is performed. The length of one symbol may be 71.4 μs. When another SCS is used, the same or similar method as the above-described method may be applied. When the SCS is large, the LBT period may be configured within two or more symbols to secure the CCA slot duration.

In SL-U communication, the LBT period may be configured in a different time unit instead of a symbol unit. The above-described exemplary embodiments may be applied identically or similarly to the LBT period configured in a different time unit.

In the above-described SL-U communication, information on the operation, configuration, and/or application of the LBT period (e.g., LBT symbol(s)) may be specifically, independently, or commonly configured based on at least one of a resource pool, service type, priority, whether to perform a power saving operation, QoS parameter (e.g., reliability, delay), cast type, or terminal type (e.g., vehicle (V)-UE or pedestrian (P)-UE). The above-described configuration may be performed by a network and/or base station. Alternatively, the above-described information may be implicitly determined based on preconfigured parameter(s).

In the above-described exemplary embodiment, whether to apply each method (e.g., each rule) may be configured based on at least one of a condition, a combination of conditions, a parameter, or a combination of parameters. Whether to apply each method may be configured by the network and/or the base station. Whether to apply each method may be configured resource pool-specifically or service-specifically. Alternatively, whether to apply each method may be configured by PC5-RRC signaling between terminals.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a first user equipment (UE), comprising:
transmitting, to a second UE, configuration information of one or more listen before talk (LBT) symbols capable of performing an LBT operation;
transmitting scheduling information of data to the second UE;
transmitting the data to the second UE based on the scheduling information; and
receiving hybrid automatic repeat request-acknowledgement (HARQ-ACK) information for the data from the second UE,
wherein an LBT operation of the second UE for transmitting the HARQ-ACK information is performed in at least one LBT symbol among the one or more LBT symbols.

2. The method of claim 1, wherein the configuration information and the scheduling information are included in same sidelink control information (SCI) or different signaling messages.

3. The method of claim 1, wherein the one or more LBT symbols are configured within one physical sidelink feedback channel (PSFCH) slot, and the one PSFCH slot includes a PSFCH resource for transmitting the HARQ-ACK information.

4. The method of claim 1, wherein the configuration information includes at least one of a symbol index for each of the one or more LBT symbols, an index of a first LBT symbol among the one or more LBT symbols, an index of a reference LBT symbol among the one or more LBT symbols, an index of a last LBT symbol among the one or more LBT symbols, a number of the one or more LBT symbols, a symbol offset between the first LBT symbol and the last LBT symbol, a configuration periodicity of the one or more LBT symbols, or a bitmap indicating the one or more LBT symbols.

5. The method of claim 1, wherein the one or more LBT symbols are configured considering a minimum number of symbols required for transmission of the data.

6. The method of claim 1, wherein the one or more LBT symbols are configured considering a configuration periodicity of a PSFCH resource included in a PSFCH slot.

7. A method of a second user equipment (UE), comprising:
receiving configuration information of one or more listen before talk (LBT) symbols capable of performing an LBT operation;
receiving scheduling information of data from a first UE;
receiving the data from the first UE based on the scheduling information; and
performing a first LBT operation in a first LBT symbol among the one or more LBT symbols indicated by the configuration information to transmit hybrid automatic repeat request-acknowledgement (HARQ-ACK) information for the data.

8. The method of claim 7, further comprising:
in response to a failure of the first LBT operation, performing a second LBT operation in a second LBT symbol among the one or more LBT symbols; and
in response to a success of the second LBT operation, transmitting the HARQ-ACK information to the first UE.

9. The method of claim 7, wherein the configuration information is received through signaling from the first UE or a base station.

10. The method of claim 7, wherein the configuration information and the scheduling information are included in same sidelink control information (SCI) or different signaling messages received from the first UE.

11. The method of claim 7, wherein the one or more LBT symbols are configured within one physical sidelink feedback channel (PSFCH) slot, and the one PSFCH slot includes a PSFCH resource for transmitting the HARQ-ACK information.

12. The method of claim 7, wherein the configuration information includes at least one of a symbol index for each of the one or more LBT symbols, an index of a first LBT symbol among the one or more LBT symbols, an index of a reference LBT symbol among the one or more LBT symbols, an index of a last LBT symbol among the one or more LBT symbols, a number of the one or more LBT symbols, a symbol offset between the first LBT symbol and the last LBT symbol, a configuration periodicity of the one or more LBT symbols, or a bitmap indicating the one or more LBT symbols.

13. The method of claim 7, wherein the one or more LBT symbols are configured considering a minimum number of symbols required for transmission of the data.

14. The method of claim 7, wherein the one or more LBT symbols are configured considering a configuration periodicity of a PSFCH resource included in a PSFCH slot.

15. A second user equipment (UE) comprising a processor, wherein the processor causes the second UE to perform:
receiving configuration information of one or more listen before talk (LBT) symbols capable of performing an LBT operation;
receiving scheduling information of data from a first UE;
receiving the data from the first UE based on the scheduling information; and
performing a first LBT operation in a first LBT symbol among the one or more LBT symbols indicated by the configuration information to transmit hybrid automatic repeat request-acknowledgement (HARQ-ACK) information for the data.

16. The second UE of claim 15, wherein the processor further causes the second UE to perform:
in response to a failure of the first LBT operation, performing a second LBT operation in a second LBT symbol among the one or more LBT symbols; and
in response to a success of the second LBT operation, transmitting the HARQ-ACK information to the first UE.

17. The second UE of claim 15, wherein the configuration information and the scheduling information are included in same sidelink control information (SCI) or different signaling messages received from the first UE.

18. The second UE of claim 15, wherein the one or more LBT symbols are configured within one physical sidelink feedback channel (PSFCH) slot, and the one PSFCH slot includes a PSFCH resource for transmitting the HARQ-ACK information.

19. The second UE of claim 15, wherein the configuration information includes at least one of a symbol index for each of the one or more LBT symbols, an index of a first LBT symbol among the one or more LBT symbols, an index of a reference LBT symbol among the one or more LBT symbols, an index of a last LBT symbol among the one or more LBT symbols, a number of the one or more LBT symbols, a symbol offset between the first LBT symbol and the last LBT symbol, a configuration periodicity of the one or more LBT symbols, or a bitmap indicating the one or more LBT symbols.

20. The second UE of claim 15, wherein the one or more LBT symbols are configured considering a minimum number of symbols required for transmission of the data or a configuration periodicity of a PSFCH resource included in a PSFCH slot.
